(19) United States
(12) Patent Application Publication
(10) Pub. No.: US 2023/0112440 A1
(43) Pub. Date: Apr. 13, 2023

(54) METHOD FOR FORMING NOBLE METAL NANOSTRUCTURES ON A SUPPORT

(71) Applicant: Nanyang Technological University, Singapore (SG)

(72) Inventors: Weijiang ZHOU, Singapore (SG); Siew Hwa CHAN, Singapore (SG)

(21) Appl. No.: 17/906,152

(22) PCT Filed: Mar. 17, 2021
(86) PCT No.: PCT/SG2021/050139

§ 371 Date: Sep. 12, 2022

(30) Foreign Application Priority Data
Mar. 17, 2020 (SG) 10202002435Y

(51) Int. Cl. H01M 4/86; H01M 4/88; H01M 4/90

(52) U.S. Cl. CPC H01M 4/8652; H01M 4/885; H01M 4/8828; H01M 4/8878; H01M 4/9016; H01M 4/9083

(57) ABSTRACT

The disclosure provides a method for forming noble metal nanostructures on a support. The method comprises mixing one or more noble metal precursor with a first solvent and a base to obtain a noble metal precursor solution; feeding the noble metal precursor solution to a spiral tube reactor; heating the spiral tube reactor containing the noble metal precursor solution to reduce the one or more noble metal precursor to obtain noble metal nanostructures; and mixing a support ink with the noble metal nanostructures obtained after heating, wherein the support ink comprises a second solvent, the support and an ink acid. There are also provided noble metal nanostructures on a support and a use thereof as an electro-catalyst in an electrode for fuel cell applications.

### CROSS-REFERENCE TO RELATED APPLICATION

This application claims the benefit of priority of Singapore Patent Application No. 10202002435Y, filed 17 Mar. 2020, the contents of it being hereby incorporated by reference in its entirety for all purposes.

### TECHNICAL FIELD

Various aspects of this disclosure relate to a method for forming noble metal nanostructures on a support. Various aspects of this disclosure also relate to the noble metal nanostructures on a support and their use.

### BACKGROUND

As one of the most important clean energy conversion devices, a fuel cell can convert chemical energy resulting from the oxidation of fuels directly into electrical energy. The commercialization of the low-temperature fuel cells, in particular the proton exchange membrane fuel cells (PEMFCs) is gradually beginning, particularly in automobile-related fields, backup power, household use, portable and mobile power source, because low-temperature fuel cells have advantages in improved fuel efficiency, reduced emission, and are more environmentally friendly compared to their internal combustion engines counterparts.

PEMFCs fueled by hydrogen or methanol/ethanol (the latter is also known as direct methanol/ethanol fuel cells, DM(E)FCs) are characterized in that they exhibit a wide operating temperature range from -40° C. to 180° C. (depending on the solid electrolyte properties), a quick start-up and response, and high output power density which allows the PEMFCs system to be readily smaller and lighter than conventional fuel cells. PEMFCs are considered as the most suitable and best partner to promote the intelligentization of the various automobiles due to their excellent attributes such as the high power density and long-time power supplying.

The core of PEMFCs is membrane-electrode assembly (MEA) which is composed of a solid electrolyte sandwiched in between two catalytic electrodes. The electrode used generally contains a catalyst layer, a macro-porous layer and a backing layer. The catalyst layer and the macro-porous layer can be supported on a backing layer to make up the independent electrode such as cathode or anode, which are then used to sandwich the solid electrolyte membrane generally by hot-press to obtain the final MEA. In the past 10 years, the employment of a catalyst-coated membrane (CCM) became more important because of the closer contact between the catalyst layer and the solid electrolyte membrane and consequently a higher performance. In the CCM, the catalyst layer is prepared by fixing the catalyst ink or slurry directly on the solid electrolyte.

In order for the fuel oxidation and oxygen reduction reaction in a fuel cell to occur at desired electrochemical kinetic rates and potentials, highly active and durable electro-catalysts are required. Due to the high catalytic nature and chemical stability, the scarce platinum and platinum alloy materials, supported or unsupported, are preferred to be the electro-catalysts for the anode and cathode in low-temperature fuel cells.

In current hydrogen-fed PEMFCs, around 75% of precious metals are used as a cathode catalyst to accelerate the sluggish oxygen reduction reaction. The high loading and the high cost of the scarce platinum constitute the biggest cost percentage of the PEMFCs stack, around 40%. The cost and the cost-effectiveness of the CCM and the PEMFC stack determine the application and commercialization. Hence, it is desirable to reduce the use of platinum in the cathode, which would lead to a more affordable fuel cell system as a whole and enhance commercialization.

Two effective routes can be employed to reduce the electrode catalyst cost and therefore the cost of a PEMFC stack as a whole. One way is to employ non-precious metal catalysts or non-metallic catalysts for electrochemical reactions, which is much cheaper compared to the noble metallic catalysts and more attractive and interesting. However, although researchers are striving to improve the quality of the catalysts, the current use of non-precious metal catalysts such as nitrogen and transition metal(s) doped carbon materials are still limited by their restricted activity in the acidic environment of solid polymer proton conducting electrolyte. Due to this reason, non-platinum catalysts that were developed have little opportunity to replace platinum-based catalysts, at least not in the foreseeable future.

Another way to reduce the electrode catalyst cost is to increase the platinum-based electro-catalyst activity, and as a matter of course the platinum loading in the CCM can be decreased to increase the cost-effectiveness.

A further challenge lies in the catalyst preparation. So far, most disclosures on the PGM-based (platinum group metal) catalyst preparation especially for those of high metal loading are non-continuous, for example in a batch-by-batch model, and are only suitable for small-batch production. Differences in catalyst properties are inevitable in different batches of catalyst production. Therefore, there remains a need to provide improved methods for preparing noble metal nanostructures suitable for use as a catalyst for fuel cell applications, for example. There also remains a need to provide improved noble metal nanostructures.

### SUMMARY

In a first aspect, there is provided a method for forming noble metal nanostructures on a support. The method may include mixing one or more noble metal precursor with a first solvent and a base to obtain a noble metal precursor solution. The method may further include feeding the noble metal precursor solution to a spiral tube reactor. The method may further include heating the spiral tube reactor containing the noble metal precursor solution to reduce the one or more noble metal precursor to obtain noble metal nanostructures. The method may further include mixing a support ink with the noble metal nanostructures obtained after heating, wherein the support ink includes a second solvent, the support and an ink acid.

In a second aspect, there are provided noble metal nanostructures on a support. The noble metal nanostructures on a support may be produced by the method as defined above.

In a third aspect, there is provided use of the noble metal nanostructures on a support as defined above. The use may include use as an electro-catalyst in an electrode for fuel cell applications.

### BRIEF DESCRIPTION OF THE DRAWINGS

The invention will be better understood with reference to the detailed description when considered in conjunction with the non-limiting examples and the accompanying drawings, in which:

FIG. 1 shows a flow chart of an example of the present preparation procedure for ultrafine nanosized catalysts;

FIG. 2 is a schematic view showing the setup for the synthesis of the nanosized platinum catalyst supported on carbon according to an embodiment;

FIG. 3 is a schematic view showing the structure of the spiral glass tube reactor of FIG. 2 having two concurrent spiral glass tubes according to an embodiment;

FIG. 4A shows the size histogram result of Pt/C-a of Example 5 (40 wt% Pt);

FIG. 4B shows the TEM characterization result of Pt/C-a of Example 5 (40 wt% Pt);

FIG. 5A shows the size histogram result of Pt/C-b of Example 6 (40 wt% Pt);

FIG. 5B shows the TEM characterization result of Pt/C-b of Example 6 (40 wt% Pt);

FIG. 6A shows the size histogram result of Pt/C of Example 7 (60 wt% Pt);

FIG. 6B shows the TEM characterization result of Pt/C of Example 7 (60 wt% Pt);

FIG. 7A shows the size histogram of platinum nanostructures supported on graphene, having a metal loading of 60 wt%;

FIG. 7B shows the TEM characterization result of platinum nanostructures supported on graphene, having a metal loading of 60 wt%;

FIG. 8A shows the size histogram of platinum nanostructures supported on graphene, having a metal loading of 30 wt%;

FIG. 8B shows the TEM characterization result of platinum nanostructures supported on graphene, having a metal loading of 30 wt%;

FIG. 9A shows the size histogram of platinum-cobalt nanostructures supported on carbon powder, having a metal loading of 40 wt%;

FIG. 9B shows the TEM characterization result of platinum-cobalt nanostructures supported on carbon powder, having a metal loading of 40 wt%;

FIG. 10A shows the size histogram of platinum-ruthenium nanostructures supported on carbon powder, having a metal loading of 50 wt%;

FIG. 10B shows the TEM characterization result of platinum-ruthenium nanostructures supported on carbon powder, having a metal loading of 50 wt%;

FIG. 11A shows the size histogram of platinum-ruthenium-iridium nanostructures supported on graphene, having a metal loading of 75 wt% (Example 12);

FIG. 11B shows the TEM characterization result of platinum-ruthenium-iridium nanostructures supported on graphene sample with total metal loading of 75 wt% (Example 12);

FIG. 12 shows a comparison in the electrochemical performance of platinum supported on carbon powder (Pt/C), having a metal loading of 40 wt%, obtained by the inventive method (Example 6) vs platinum supported on carbon powder (Pt/C), having a metal loading of 40 wt%, obtained by a non-inventive method (Example 13); all electrochemical experiments (linear sweep voltammetry (LSV) and cyclic voltammetry (CV)) were conducted in 0.1 M perchloric acid aqueous solution at room temperature with a scan rate of 10 mV/s.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

In a first aspect, the present disclosure refers to a method for forming noble metal nanostructures on a support. The method may include mixing one or more noble metal precursor with a first solvent and a base to obtain a noble metal precursor solution. The method may further include feeding the noble metal precursor solution to a spiral tube reactor. The method may further include heating the spiral tube reactor containing the noble metal precursor solution to reduce the one or more noble metal precursor to obtain noble metal nanostructures. The method may further include mixing a support ink with the noble metal nanostructures obtained after heating, wherein the support ink includes a second solvent, the support and an ink acid.

Advantageously, the method disclosed herein provides for noble metal nanostructures on a support having an increased electrochemical surface area and an increased kinetic current density as compared with conventional methods for forming noble metal nanostructures on a support, having the same noble metal loading. In particular, an electrochemical surface area of 64.2 m²/g Pt and a kinetic current density of 0.95 mA/cm² was obtained for an example of the present disclosure at a noble metal loading of only 40 wt%. This example illustrates that it is possible to increase the efficiency of the noble metal as an electro-catalyst while using the same amount of noble metal. A higher loading of the expensive noble metals in membrane-electrode assembly can thus be avoided, thereby increasing the cost-effectiveness. The higher electrochemical surface area and the increased kinetic current density is believed to be the result of a different reaction step sequence, as compared with the conventional methods. In particular, a comparative example includes mixing the support with the one or more noble metal precursor and subsequently heating the ensuing mixture to obtain noble metal nanoparticles on a support. In contrast, the present disclosure provides a method wherein a noble metal precursor solution containing the one or more noble metal precursor is first heated in a spiral tube reactor, before being mixed with a support ink to obtain the noble metal nanostructures on a support. Said difference in reaction sequence results in the advantageous properties of the noble metal nanostructures on a support obtained according to the disclosure.

The method presented herein advantageously involves a rapid and consecutive flow reduction which can save power, time and preparation cost. This is because it allows for mass-production, especially the facile production, of the noble metal nanostructures on a support with high total metal content, for example higher than 20 wt% (weight percentage), which is quite suitable for many chemical industries, low-temperature fuel cells, electrolysis and so on. In particular, the total metal loading based on the total mass of the noble metal nanostructures and the support can be 1 wt% and above, 5 wt% and above, 10 wt% and above, or about 20 wt% or more. If desired, a higher metal loading could also be obtained by using the disclosed method. For example, the total metal mass content of the as-formed noble metal nanostructures can be more than 30 wt%, or between 30 wt% and 50 wt%, or more than 60 wt%, and if desired as high as 75 wt%, or as high as 80 wt% of the total mass of the noble metal nanostructures on a support.

Further advantageously, the method does not require the use of a surfactant. In other words, no expensive and cumbersome surfactants are needed for the reduction step, therefore making the synthesis method economically attractive and easy to operate.

A “nanoparticle” or “nanostructure”, as used herein, refers to a particle or product having a characteristic length such as diameter, in the range of up to 100 nm, and optionally less than 30 nm, optionally less than 10 nm, or less than 5 nm in the field of noble metallic catalysts. Examples of a noble metal include at least one of platinum-group (noble) metals (abbreviated as PGMs herein) i.e., platinum, ruthenium, palladium, gold, silver, rhenium, rhodium, iridium, osmium, or a combination thereof. Generally, other transition metals used with this disclosure to prepare PGMs-based nanosized materials are named and abbreviated as non-PGMs herein.

In some embodiments, the noble metal nanostructures contain at least one noble metal.

In some embodiments, the noble metal nanostructures are nanoparticles comprising or consisting essentially of platinum.

In one embodiment, the noble metal nanostructures are platinum nanostructures.

The noble metal nanoparticles or nanostructures may have a regular shape, or may be irregularly shaped. For example, the noble metal nanostructure may be a sphere, a rod, a cube, or irregularly shaped. The size of the noble metal nanostructures may be characterized by their mean diameter, or mean diameter of the nanosized rod cross section. The term “diameter” as used herein refers to the maximal length of a straight line segment passing through the center of a figure and terminating at the periphery. The term “mean diameter” refers to an average diameter of the nanostructures and may be calculated by dividing the sum of the diameter of each nanostructure by the total number of nanostructures. Although the term “diameter” is used normally to refer to the maximal length of a line segment passing though the centre and connecting two points on the periphery of a nanosphere, it is also used herein to refer to the maximal length of a line segment passing through the centre and connecting two points on the periphery of nanostructures having other shapes, such as a nanocube or nanotetrahedra, or an irregular shape. In various embodiments, the noble metal nanostructures are essentially monodisperse.

The produced noble metal nanostructures mentioned above may contain nanosized alloys or core-shell particles which may contain at least two metallic elements in which at least one noble metal is contained. The mass percentage of the noble metal or noble metals in the total metals (i.e., one or more noble metals and a transition metal) of the nanosized alloys or core-shell particles may be more than 30 wt%, e.g., more than 40 wt%.

The noble metal nanostructures obtained after heating may contain core-shell nanoparticles, which may include at least two or more than two different metals, one of which being the noble metal and the at least one other metal being the transition metal. The core-shell modification may be the result of a different reduction sequence of two different metal precursor or more than two different metal precursor, for example, in the heating step of the method. In one embodiment, the noble metal precursor may be a platinum precursor and the transition metal precursor may be selected from a cobalt precursor, a nickel precursor, an iron precursor or a combination thereof. Due to the transition metal precursor in that embodiment being reduced earlier than the platinum precursor, a core-shell nanoparticle may be formed, wherein the core has a higher mass percentage of the prior reduced transition metal and the shell has a higher mass percentage of the subsequently reduced platinum. Accordingly, the mass percentages between the noble metal and the transition metal in the shell may be different from the mass percentages between the noble metal and the transition metal in the core. Either the shell or the core may be rich in one metal and doped by one or more of other metals. Hence, the shell of the core-shell nanoparticles may have a higher mass percentage of the noble metal than the core. In other words, the shell may be rich in the noble metal. In particular, of the total mass percentage of the metals in the shell of the core-shell nanoparticles, the mass percentage of the noble metal may be more than 50 wt%, or more than 60 wt%. Vice versa, the core may be rich in the transition metal. In particular, of the total mass percentage of the metals in the core of the core-shell nanoparticles, the mass percentage of the noble metal may be less than 50 wt%, or less than 40 wt%.

The noble metal nanostructures obtained after heating may contain nanostructures of less than 30 nm (nanometers), optionally less than 20 nm, optionally less than 10 nm, optionally less than 2.5 nm diameter. In the core-shell nanostructures, the shell thickness may be at least 2 atomic layers.

Another avenue to improve the noble metal nanostructures on a support may be to produce more surface active sites and therefore increase the available reaction sites in the electrode’s catalyst layer or the so-called three-phase boundaries inside the catalyst layers. Reducing the noble metal nanostructures’ sizes may result in a specific mass availability of platinum active sites, activity and improve the cost-effectiveness of expensive platinum to a large extent.

Advantageously, the present method affords the synthesis of noble metal nanostructures having a mean diameter of about 2.8 nm or less, such as about 2.5 nm, 2.2 nm, 1.8 nm, 1.7 nm, or even less, with narrow distribution. The size range of the noble metal nanostructures on a support is from about 1.2 nm to 3.8 nm with narrow distribution and the specific mass surface area of the noble metal can be as high as 151.0 m²/g. “Narrow distribution” as used herein may refer to at least 90% of the particles being in the stated range. In one embodiment, the mean diameter of the noble metal nanostructures, such as platinum nanostructures, is between about 1.5 nm to about 3 nm, or about 1.8 nm. The noble metal nanostructures on a support have a high specific metallic surface area and a high surface particle density. For embodiments having more than one metal present in the noble metal nanostructures on a support, and by using the method as disclosed herein, the average diameter (i.e. the particle size) of the noble metal nanostructures on a support may be lower than 3.0 nm, and for bimetallic noble metal nanostructures even lower than 2.2 nm. Advantageously, this provides the synergistic effect that the cost-effectiveness of the catalyst material can be enhanced by improving the specific mass availability due to the small particle size, and also by replacing the noble metal (e.g. platinum) with more cost-effective materials.

The method may start with the preparation of the noble metal precursor solution. The noble metal precursor solution may contain one or more noble metal precursor, or mixed metallic precursors including at least one noble metal precursor and at least one transition metal precursor. In the following, (i) one or more noble metal precursor or (ii) one or more mixed metallic precursor shall be referred to as “catalytic metal precursor(s)”. In various embodiments, the noble metal may include platinum, ruthenium, palladium, gold, silver, rhenium, rhodium, iridium, osmium, or a combination thereof. In various embodiments, the one or more noble metal precursor includes an oxide, a halide, a nitrite, a sulphate, or a complex of platinum, ruthenium, palladium, gold, silver, rhenium, rhodium, iridium, osmium, or a combination thereof. “Halide” as used herein refers to F⁻, Cl⁻, Br⁻, and I⁻.

In one embodiment where the noble metal nanoparticles include platinum nanoparticles, the noble metal precursor solution may include hexachloroplatinic acid (H₂PtCl₆•6H₂O) or the respective chloroplatinates such as but not limited to sodium, ammonium or potassium chloroplatinate.

In some embodiments, the noble metal precursor solution may further include a transition metal precursor. The term “transition metal” is to be interpreted broadly to include any element in which the filling of the outermost shell to eight electrons within a periodic table is interrupted to bring the penultimate shell from 8 to 18 or 32 electrons. Transition elements may include, without limitation, scandium, titanium, vanadium, chromium, manganese, iron, cobalt, nickel, copper, zinc, ytterbium, zirconium, niobium, molybdenum, silver, lanthanum, hafnium, tantalum, tungsten, rhenium, rare-earth elements, cerium, praseodymium, neodymium, promethium, samarium, europium, gadolinium, terbium, dysprosium, holmium, erbium, thulium, yttrium, lutetium, and rhodium. Included in this definition are post-transition metals, which may refer to the metallic elements in the periodic table located between the transition metals (to their left) and the metalloids (to their right). These elements may include gallium, indium, thallium, tin, lead, bismuth, cadmium, mercury and aluminum. In one embodiment, the transition metal precursor may be selected from the group consisting of an iron cation, a ruthenium cation, an osmium cation, a cobalt cation, a rhodium cation, a nickel cation, an iridium cation, and a combination thereof. The transition metal precursor may include transition metals cations from group 8 or 9 of the period system.

This addition of the transition metal precursor may result in obtaining noble metal nanostructures from a noble metal precursor solution wherein the one or more noble metal precursor is reduced together with the transition metal precursor. Both precursors would be reduced into their respective elemental states. Such joint reduction may result in the formation of a noble metal alloy or other mixed modifications. In particular, the obtained multi-metallic noble metal nanostructures may exist on the support as an alloy nanostructure, a core-shell nanostructure, separated nanostructure or other compound modifications. Advantageously, by alloying the one or more noble metal (e.g., platinum) of the noble metal nanostructures with various less-expensive materials, the amount of noble metal (e.g. platinum) that is required may be decreased, thereby increasing cost-effectiveness. Additionally or alternatively, the total activity of the ensuing electro-catalyst may be increased. For example, noble metal nanostructures in the form of core-shell nanostructures such as platinum thin shells capped on other (e.g., cheaper) metallic cores or metal-oxide cores may be beneficial in reducing the use of the noble metal and increasing the catalytic activity. Advantageously, the durability of the noble metal nanostructures may also be increased.

The noble metal precursor solution may further include a first solvent. The first solvent used to dissolve the catalytic metal precursors may be the same, or may be different. In some embodiments, the first solvent may be selected to dissolve different catalytic metal precursors. In other embodiments, the catalytic metal precursors are each dissolved in different first solvents to obtain respective solutions and then the solutions are mixed to obtain the noble metal precursor solution containing at least two catalytic metal precursors.

The first solvent may be an organic solvent. Advantageously, because the first solvent may be an organic solvent, dissolving the catalytic metal precursor(s) may be facilitated. The organic solvent may have several functions besides dissolving the catalytic metal precursor(s) such as reducing the catalytic metal precursor(s), and/or enhancing the speed of the reduction reaction, preventing metallic particle aggregation and/or growth, maintaining fine dispersion of the noble metal nanostructures obtained after heating, et al. The first solvent may comprise or consist of a polyhydric alcohol. Optionally, the polyhydric alcohol may be balanced with a varying proportion of other solvents selected from the group consisting of, but not limited to, water, alcohols, ethers and ketone and a combination thereof. The polyhydric alcohol may be ethylene glycol. In certain embodiments, the noble metal precursor solution may include the polyhydric alcohol, e.g. ethylene glycol, and another solvent such as but not limited to water, or ethanol, or methanol, or propanol, or all of the solvents listed with varying proportion. Optionally, the ethylene glycol content in the mixed solution may range from 20 vol% (volume percentage) to 100 vol%, and more preferably from 40 vol% to 100 vol%, and further more preferably from 70 vol% to 100 vol%. The ethylene glycol solution may be used to dissolve the catalytic metal precursor(s).

The noble metal precursor solution further comprises a base. The base may be used to adjust and maintain the pH of the noble metal precursor solution in an alkaline pH range, in which the pH of the noble metal precursor solution is higher than 7, optionally higher than 8, optionally higher than 8.5, optionally higher than 9.5, optionally at about 10. Such high pH values may advantageously accelerate the reduction of the catalytic metal precursor in the noble metal precursor solution during heating in the spiral tube reactor.

As mentioned, in various embodiments, a transition metal precursor may be added to the noble metal precursor solution. The molar ratio between one of the one or more noble metal precursors to the transition metal precursor may be between 10:1 to about 1:5, optionally between 10:1 to about 1:2, optionally between 2:1 to about 4:5, optionally between 5:4 to about 4:5, optionally between 2:1 to about 1:4, optionally between 3:1 to about 1:3, optionally at about 1:1.

The base may be an organic base or an inorganic base. The organic base may comprise ammonium hydroxide. The inorganic base may comprise a hydroxide of sodium or potassium. A solvent used to dissolve the base may be selected to be the same one used to dissolve the one or more noble metal precursors. The molar concentration of the base in the noble metal precursor solution may be less than 10 moles per liter (M/L).

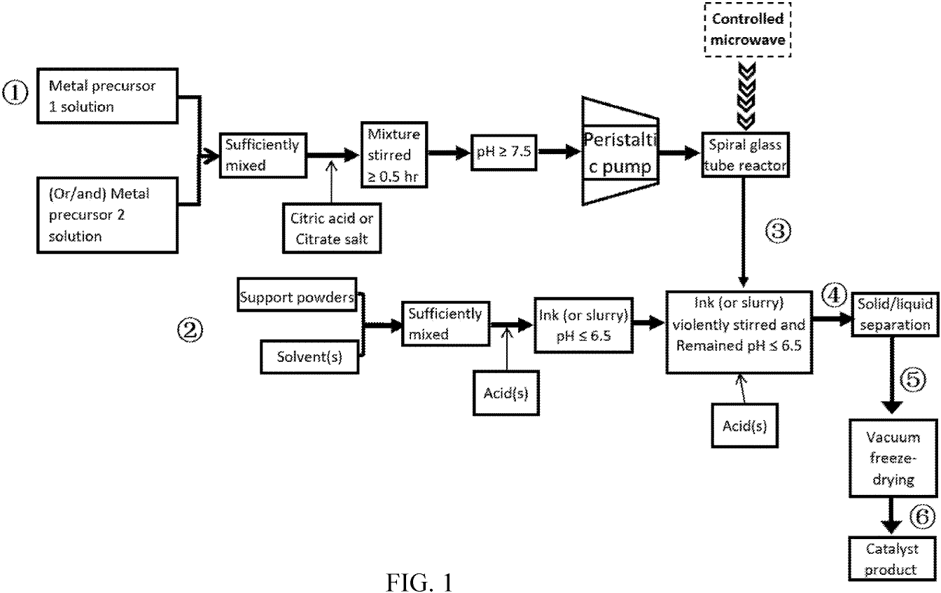

In some embodiments, the noble metal precursor solution may further include a polybasic carboxylic acid and/or its salt. The polybasic carboxylic acid and/or its salt may be included in the noble metal precursor solution before being fed into the spiral tube reactor. In particular, the one or more noble metal precursor may be first mixed with the first solvent and the polybasic carboxylic acid and/or its salt, and subsequently, the base may be added to increase the pH value of the noble metal precursor solution. In other words, and as exemplified in FIG. 1, prior to feeding the noble metal precursor solution into the spiral glass tube reactor and heating, the noble metal precursor solution containing the catalytic metal precursor(s) may be first mixed with a polybasic carboxylic acid and/or its salt.

The polybasic carboxylic acid and/or its salt may be selected from a group consisting of citric acid, tartaric acid, malic acid, oxalic acid, and/or their salts. Optionally, the polybasic carboxylic acid and/or its salt may include citric acid and/or a citrate of sodium or potassium. The molar ratio of the polybasic carboxylic acid and/or its salt to the catalytic metal precursor(s) may range from 0.01 to 100, optionally 0.05 to 20, optionally 0.1 to 10. Advantageously, it has been found that the addition of polybasic carboxylic acid and/or its salt (e.g., citric acid and/or citrate) to the noble metal precursor solution prior to heating and reducing to the noble metal nanostructures aids to stabilize the noble metal nanostructures obtained after heating and to reduce the nanostructure average size. Hence, the formation of uniformly dispersed noble metal nanostructures on a support can be achieved.

By “mixing” is meant contacting one component with another component. The order of mixing the various catalytic metal precursors is generally not critical, unless stated otherwise. For example, a first noble metal precursor solution may be mixed with a second noble metal precursor before optionally adding a transition metal precursor, optionally in a solution. Alternatively, all three or more metal precursor solutions may be simultaneously added to and therefore mixed in a common container. In another alternative, all catalytic metal precursors including at least one noble metal precursor can be simultaneously added into a solvent to make the noble metal precursor solution in a common container. In FIG. 1, it is illustrated as an example that two separate (and different types of) noble metal precursors, or one noble metal precursors and another transition metal precursor may be mixed together. It is to be understood that in certain embodiments, only one noble metal precursor may be used while in other embodiments, two, three, four, or even more (different types of) noble metal precursor or other transition metal precursor may be mixed. The noble metal precursor solution may thus contain more than one catalytic metal precursor.

In this disclosure, at least two solutions or two mixtures of different solvents are used to dissolve the chemicals or disperse the supports. The first solution, solvent or the mixture of several solvents, called the noble metal precursor solution herein, is used to dissolve the catalytic metal precursor(s), the base, and optionally other chemicals. The first solvent may be the liquid contained in the noble metal precursor solution before the noble metal precursor solution is fed into the spiral tube reactor to conduct the reduction reaction. The second solution may be the support ink which is used to disperse the support, and to dissolve the chemicals, such as but not limited to an ink acid. The ink acid may mix with the support ink and modify the pH value of the support ink.

In various embodiments, as exemplified in FIG. 1, the prepared noble metal precursor solution is fed into the spiral tube reactor and heated to reduce the catalytic metal precursor(s) and to produce the noble metal nanostructures. By “heating” is meant that the temperature of the noble metal precursor solution containing the catalytic metal precursor(s) is deliberately raised such that a reduction process can take place. Heating may thus involve to raise the temperature above room temperature. “Room temperature”, as used herein, refers to a temperature greater than 4° C., preferably being in the range from 15° C. to 40° C., or in the range from 15° C. to 30° C., or in the range from 20° C. to 30° C., or in the range from 15° C. to 24° C., or in the range from 16° C. to 21° C., or around 25° C. Such temperatures may include, 14° C., 15° C., 16° C., 17° C., 18° C., 19° C., 20° C., 21° C., and 25° C., each of these values including ± 0.5° C. Heating the noble metal precursor solution may include the noble metal precursor solution to be heated for less than one hour, or less than half an hour, or for about a time period selected from 2 min to about 50 min, or for about a time period selected from 5 min to about 15 min. Advantageously, the spiral tube reactor allows for a very short heating time.

The reduction may involve a reduction of the catalytic metal precursor(s) to an elemental reduction state.

In one embodiment, heating includes irradiation of the spiral tube reactor in a microwave reactor or a millimeter reactor. The microwave reactor may be operated at a wavelength of about 1 cm to about 1 m, optionally at a wavelength of about 5 cm to about 50 cm, optionally of about 10 cm to about 15 cm. The millimeter reactor may be operated at a wavelength of about 1 mm to about 10 mm, optionally of about 2 mm to about 5 mm. Advantageously, the microwave reactor or millimeter reactor produces heat which is tune-able and therefore controllable.

In other words, the method further includes heating, optionally by microwave or millimeter wave, the spiral tube reactor containing the noble metal precursor solution to reduce the catalytic metal precursor(s) and form noble metal nanostructures. Advantageously, such method further affords controllable and localized heating which can further save energy and improve effectiveness of the chemical reduction process.

By introducing the noble metal precursor solution into a spiral tube reactor, a continuous and quick flow-reduction heating is achieved whereby only a small region is selectively heated. The noble metal precursor solution may be fed to the spiral tube reactor by a pump, such as, but not limited to, a peristaltic pump, or other measures well-known to the operator in the art. Thus, a continuous flow of small amount of mixed reactant is heated and chemically reduced simultaneously in a very short time window. This may lead to complete and uniform heat reduction of the catalytic metal precursor(s) to get uniformly dispersed noble metal nanostructures in the selected solution, which is crucial in large volume production with energy savings. It also enables the reduction of the catalytic metal precursor(s) and their uniform distribution of noble metal nanostructures after deposition on the surface of the support. Advantageously, smaller particle size (for example 2.0 nm) with narrow size distribution and, if desired, a high metal loading (up to 80 wt%) are achieved.

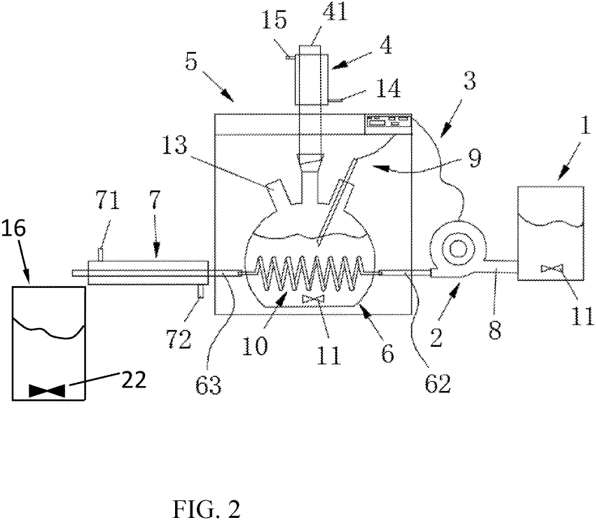

The setup for the continuous production of the noble metal nanostructures is demonstrated and exemplified in FIG. 2. The container 1 with electromagnetic stirrer 11 (or other agitation auxiliaries known to the operator in the field) is used to store the noble metal precursor solution. All the materials are dispersed very uniformly and prepared before being transferred by the pump 2 through the tube 8 into the spiral reactor 10. The spiral reactor 10 is immersed in and across the heating oil stored in flat-bottom three-neck flask 6. The heating oil, which is stirred by electromagnetic stirrer 11 (or other agitation auxiliaries known to the operator in the field), is used to maintain the stable temperature. One of the side necks of the flask 6 is connected with the temperature sensor 9 which is connected to the controller of the microwave reactor 5 to measure and control the temperature of the heating oil. Another side neck 13 is connected with a discharge line in order to avoid the heating oil overflow due to possible overheating. A condenser 4 is connected to the main neck of the flask 6 to reflux the heating oil during operation. The control unit of the microwave reactor 5 is also connected by the wire 3 to control the pump 2. The starting up and shutting down of the pump 2 is controlled by the control unit of microwave reactor 5, and also related to the actual temperature of the heating oil in flask 6. Tubes 62 and 63 are used for the flow before and after the reactor. Condenser 7 is used to cool down the temperature of produced noble metal nanostructures from reactor before the noble metal nanostructures are introduced into container 16 to mix with the support ink or slurry and deposit the noble metal nanostructures onto the support surface. An electromagnetic stirrer 22 (or other agitation auxiliaries known to the operator in the field) is used in container 22 to keep the support ink or slurry vigorously stirred.

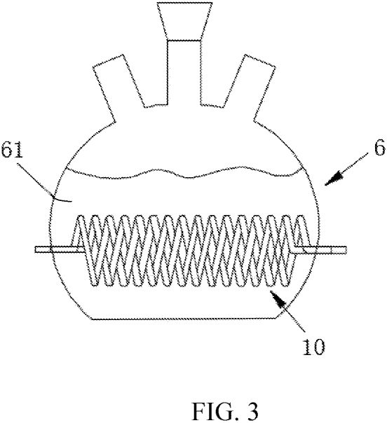

In some embodiments, the spiral tube reactor has one spiral tube. In other embodiments, the spiral tube reactor has more than one spiral tube wherein at least two spirals of the more than one spiral tube run concurrent to each other. In other words, more than one spiral tube can be used and installed in spiral tube reactor as demonstrated in FIG. 3. The more than one spiral tube may be connected in parallel. Advantageously, this increases the catalyst production rate with more uniform heat distribution and with decreased operation time. For example, with one tube, the optimal flow rate is 50 milliliters per min, the total flow rate can reach 150 milliliters per minute when three spiral tubes are merged into the reactor. Further, by using more than one spiral tube that may be connected in parallel, the mechanical resistance may be reduced, thereby further increasing the flow rate and decreasing operation time. Moreover, the first tube and the second tube may be intertwined, for example as a double helix. Such an arrangement is advantageously space-efficient, particularly in combination with an embodiment wherein the spiral tube reactor is immersed in a heating medium. Furthermore, the one or more spiral tubes may run substantially horizontal, i.e., an axis around which the tubes are coiled may be a horizontal axis. This may allow for a more even flow of the noble metal precursor solution.

In one embodiment, heating includes increasing the temperature in the spiral tube reactor to a range of between 60° C. to 250° C., or to a range of between 90° C. to 190° C., or to a range of between 120° C. to 170° C. The exact temperature is also related to the liquid medium properties.

The spiral tube reactor, and/or the spiral tube(s), may be made from glass, PTFE (Polytetrafluoroethylene), or combinations thereof. In one embodiment, the spiral tube reactor and/or the spiral tube(s) is a spiral glass tube reactor and/or spiral glass tube(s). The spiral tube reactor is selected to accelerate the facile and rapid reduction of the metallic precursors and scale up the mass-production of the noble metal nanostructures. As an example, over 1000 gram of catalytic metal precursor(s) may be reduced in 8 hours by using the spiral tube reactor. In one embodiment, the spiral tube reactor may be immersed in a heating medium. Advantageously, this may promote the reduction reaction at a stable temperature. For example, the spiral tube reactor as shown in FIG. 2 and FIG. 3 is fixed in a flat bottom flask and immersed in a heating medium such as heating silicone oil. The diameter of the spiral tube in the spiral tube reactor, as illustrated in FIG. 2 and FIG. 3, may be in a range of about 0.01 cm to 6 cm, optionally 0.05 cm to 4 cm, optionally 0.1 cm to 4 cm, preferably 0.1 cm to 2.5 cm. The spiral tube reactor may be specially designed and aimed with a safety valve and thermocouple. The flow rate in every spiral tube may be from 5 milliliters per minute (mL/min) to 200 mL/min, optionally from 5 mL/min to 150 mL/min, preferably from 5 mL/min to 120 mL/min, more preferably from 5 mL/min to 100 mL/min.

The method further includes mixing a support ink with the noble metal nanostructures obtained after heating. The support ink may include a second solvent. The support ink may include the support. The support ink may include an ink acid. The mixing may include feeding the solution obtained after heating, which includes the noble metal nanostructures and alkaline, into the support ink, which is acidic due to presence of the ink acid.

In some embodiments, the mass ratio of the total metals of the noble metal nanostructures to the support may be from 1:99 to 90:10. More preferably, the mass ratio of noble metal nanostructures to the support may be from 5:95 to 80:20. The volume ratio of the second solvent of the support ink to the first solvent of the noble metal nanostructures may be at least 1, optionally at least 2.

In some embodiments, the support ink may include a support or a support mixture or composite which contains several supports of the same elements or different elements. The term “support”, when used in connection with the noble metal nanostructures, means a supporting structure or a supporting material for supporting the noble metal nanostructures. Generally, any support capable of supporting and providing adequate dispersion for the noble metal nanostructures may be used. The support may be stable in the local environment where the noble metal nanostructures are to be used, for example as a catalyst layer in an electrode for low-temperature fuel cell applications. The support may preferably have a specific surface area and/or porosity sufficient to provide dispersion of the noble metal nanostructures.

In some embodiments, the carbon support may contain one or more carbon materials, which may include carbon materials treated by oxidizing or doping of other elements including nitrogen, sulphur, boron, halogens, or hydrogen or/and transition metals, such as but not limited to, cobalt, iron, zinc, nickel, manganese, molybdenum and so on. The treatment may also include a heat treatment in reducing atmosphere and/or inert atmosphere, solution, and surface functionalization by various chemicals before use.

In one embodiment, the support may include carbon black, carbon nanotubes, graphene, graphene oxide, carbon fibers, carbon mesospheres, or a combination thereof.

In some embodiments, the support may undergo an acid treatment before mixing with the second solvent. The acid treatment may include exposing the support to a support acid in an aqueous solution. Advantageously, when the support is treated in an aqueous solution, the support does not dissolve in the solution and may be separated easily from the aqueous solution after the acid treatment, for example by filtration. The support acid may include an inorganic acid, optionally selected from the group consisting of sulfuric acid, hydrochloric acid, nitric acid, and a combination thereof. The acid treatment may include heating the support in the aqueous solution comprising the support acid to a temperature above 80° C. Advantageously, by carrying out the acid treatment, impurities are removed and the support surface can be functionalized.

In some embodiments, the support may have a surface area higher than 20 m²/g.

The support ink may be dissolved in the second solvent. The second solvent used to prepare the support ink may include water or a mixed solution containing water balanced with a varying proportion of other solvents such as but not limited to polyhydric alcohols, alcohols, ethers and ketones and so on. In the mixed solution to disperse the support, the volume percentage of water may be at least 50%, and more preferably at least 75%. The second solvent may be water.

The support ink may further include at least one acidic chemical, termed “ink acid”. Accordingly, a pH value of the support ink before being mixed with the noble metal nanostructures obtained after heating may be lower than 7, lower than 6.5, lower than 5.5, less than 4, optionally in a range of between 2 and 6, optionally at about 3 or less than 3. Hence, a pH value of the support ink may be maintained in the acidic pH range. The ink acid is preferably selected from an inorganic acid or an organic acid. The ink acid may be selected from the group consisting of, but not limited to, sulfuric acid, nitric acid, hydrogen chloride, formic acid, acetic acid, oxalic acid, or a mixture thereof. The molar concentration of the ink acid may be selected to maintain a pH value of the support ink in the acidic range. Accordingly, the molar concentration of the ink acid may be less than 5.5 moles per liter (M/L), or less than 3.5 moles per liter (M/L).

In various embodiments, a second solvent may be used to disperse the support in the support ink. The dispersion may be carried out by agitation, or ultrasonic agitation, or other measures well-known to the operator in the art to obtain a uniform support ink. The second solvent may include a second organic solvent and/or an aqueous solvent. The second organic solvent may include an alcohol, optionally isopropanol. The second organic solvent may also include but is not limited to alcohol, ether and ketone and so on, and optionally ethylene glycol, ethyl alcohol, propanol, methanol, propylene glycol, or a mixture of the solvents listed above with varying proportion. The addition of the second organic solvent may promote the dispersion of the support.

Preferably the second solvent may further include an aqueous solution of the ink acid. The aqueous solution of the ink acid may be added into the second solvent to adjust the pH to below 5, or optionally to below 4. Hence, the second solvent may include water or the same solvent or solution used to disperse the support. In the second solvent, the water volume percentage may be from 10 to 100, and or optionally from 50 to 100.

Accordingly, in some embodiments, the method may further include adding an aqueous solution of the ink acid to the support ink prior to feeding the noble metal nanostructures obtained after heating into the support ink. This will decrease the pH of the support ink to below 7, such as 6, 5.5, 5, 4.5, 4, and more preferably 3.5 or even lower. The pH of the support ink may be dependent on the metal types contained in the noble metal nanostructures.

The method includes mixing a support ink with the noble metal nanostructures obtained after heating, stabilized in the first solvent. An aqueous solution of the ink acid may be constantly added during the feeding of the produced noble metal nanostructures obtained after heating into the support ink to avoid a rapid increase of the pH value of the mixture. In other words, during the mixing of the produced noble metal nanostructures with the support ink, the pH of the mixture may be maintained by adding the aqueous solution of the ink acid so as to avoid a big deviation from the initial pH value of the support ink. Mixing the support ink with the noble metal nanostructures may therefore include addition of the noble metal nanostructures to the support ink under a controlled pH value of below 5.5, optionally under a controlled pH value of below 3.5.

In this step, the noble metal nanostructures are associated to the surface of the support to form the noble metal nanostructures on a support. Hence, the term “noble metal nanostructures on a support” may involve the noble metal nanostructures being on a surface of a support. The interaction between the support and the noble metal nanostructures may be non-covalent. The association between the support and the noble metal nanostructures may be an attractive interaction between the support and the noble metal nanostructures that does not involve sharing of electrons, while resulting in adherence of the two materials. For example, such non-covalent interaction may include hydrophobic interaction, hydrophilic interaction, ionic interaction, hydrogen bonding, and/or van der Waals interaction.

After reducing the catalytic metal precursor(s) to the noble metal nanostructures and depositing the nanostructures onto the support surface, separation of the thus-formed supported noble metal nanostructures maybe be carried out by known techniques, for example, filtering and drying as shown in FIG. 1. In various illustrations, the produced mixture containing the noble metal nanostructures on the support surface is separated from the first solvent, the second solvent and optionally other dissolved chemicals by low-temperature and high-speed centrifugal separation technology, or other techniques well-known to the operator skilled in the art. After washing with copious deionized water, the solid is freeze dried or dried in a vacuum oven overnight before it can be used directly or further treated.

FIG. 1 shows illustratively a non-limiting embodiment how the disclosed method may be carried out. In step 1, the noble metal precursor solution may be prepared from one or two (noble) metal precursor solutions, comprising the catalytic metal precursor(s) and the first solvent. The solution of the one or two (noble) metal precursor solutions may be sufficiently mixed before the addition of a citric acid or citrate salt. The mixture may be stirred for at least 0.5 h and the pH of the noble metal precursor solution may be adjusted to a pH value of 7 or higher. A peristaltic pump may be used for feeding the noble metal precursor solution to a spiral glass tube reactor. The spiral glass tube reactor may be subjected to controlled microwave irradiation. In step 2, the support (or support powders) may be mixed with the second solvent and the solution may be sufficiently mixed before an ink acid is added. The pH of the support ink or slurry solution may be adjusted to a pH value of 6.5 or lower to obtain the acidic support ink. In step 3, the reaction mixture obtained from the spiral glass tube reactor may be added to the support ink, which may be stirred (e.g., in a turbulent mode). In this step, an acid solution may be added to the solution thus stirred, such that a pH value of 6.5 or lower may be maintained. In step 4, the ensuing solution may undergo solid/liquid separation, which may be followed by step 5, which may be vacuum freeze drying of the solid. Step 6 may be obtaining the catalyst product.

In a second aspect, there are provided noble metal nanostructures on a support. The noble metal nanostructures on a support may be produced by the method as defined above. Embodiments and advantages described for the method to produce the noble metal nanostructures on a support of the first aspect can be analogously valid for the noble metal nanostructures on a support of the second aspect, and vice versa. As the various embodiments and advantages have already been described above and in the examples demonstrated herein, they shall not be iterated for brevity where possible.

In a third aspect, there is provided use of the noble metal nanostructures on a support as defined above. The use may include use as an electro-catalyst in an electrode for fuel cell applications. In particular, the noble metal nanostructures on a support may be used as a catalyst layer in an electrode for low temperature fuel cell application and other electrochemical energy techniques, and other chemical industries where PGM catalysts are employed. PEMFCs including the PGM catalysts may also be used as a power source for an automobile, unmanned aerial/underwater vehicles (UAV/UUV), auxiliary power units (APU), uninterrupted Power Supply (UPS), mobile market, portables, small stationary power applications, or a power supply for a small cogeneration system such as a combined heat and power (CHP) system.

By “about” in relation to a given numerical value, such as for temperature and period of time, it is meant to include numerical values within 10% of the specified value.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

### EXAMPLES

The method described above provides a feasible and facile procedure to scale up the synthesis of noble metal nanostructures on a support, which are advantageously obtained as supported ultrafine nanosized noble metal or noble metal-based catalysts with high total metal content and high particle density on the support surface with high specific mass noble metal surface area. In various embodiments, the ultrafine nanosized particles or other types of nanostructures supported on the supporting materials may contain at least one noble metal and in some embodiments also contain at least one of other transition metals besides noble metals. The procedure is facile and scalable for the mass production of supported ultrafine nanosized noble metal-based catalysts with high total metal loading.

### Example 1 Acidic Treatment of Carbon Powder

5.0 gram of carbon powder (XC-72) was treated in 300 ml 5.0 M HNO₃ and 5.0 M HCl mixed aqueous solution by refluxing for 6 hours at 130° C. in an oil bath, and then separated from the liquid by high-speed centrifuge, washed with copious DI (deionized) water, and then freeze dried for 3 days, and further dried at 150° C. overnight. The treatment can remove the carbon powder impurity and functionalize the support surface. The acid-treated carbon powder is labelled as XC-72R.

### Example 2 Nanosized Platinum Colloid Preparation

1.08 gram hexachloroplatinic acid (H2PtCl₆•6H₂O) was dissolved in 200 mL ethylene glycol ((CH₂OH)₂, abbreviated as EG) and stirred overnight. Potassium hydroxide (KOH) was added into ethylene glycol to prepare 1.0 M/L (1 molar/liter) solution and was used to change the pH value of the above platinum precursor EG solution to 10 and stirred for 3 hours before being fed into the spiral glass tube reactor (as illustrated in FIG. 2). The liquid mixture flow was delivered into the microwave heated spiral glass tube reactor in which the reduction reaction was conducted in 10 min at a fixed temperature of 150° C. to obtain the nanosized platinum-EG colloid.

### Example 3 Nanosized Platinum Colloid Preparation

Materials used and the procedure were the same as described in Example 2, except potassium citrate tribasic monohydrate (C₆H₅K₃O₇•H₂O) was added into the hexachloroplatinic acid-EG solution before KOH ethylene glycol solution (1 molar/liter) was added into the solution. The molar ratio of hexachloroplatinic acid to citrate is 4.

### Example 4 Carbon Support Ink Preparation

0.6 gram carbon powder (XC-72R) of Example 1 was dispersed into 60 mL isopropanol ((CH₃)₂CHOH) to obtain a uniform ink, after which 360 ml DI water was added and stirred for at least 3 hours. The pH of carbon ink was adjusted to 3 by adding 0.5 M sulfuric acid aqueous solution.

### Example 5 Carbon Supported Platinum Sample Preparation

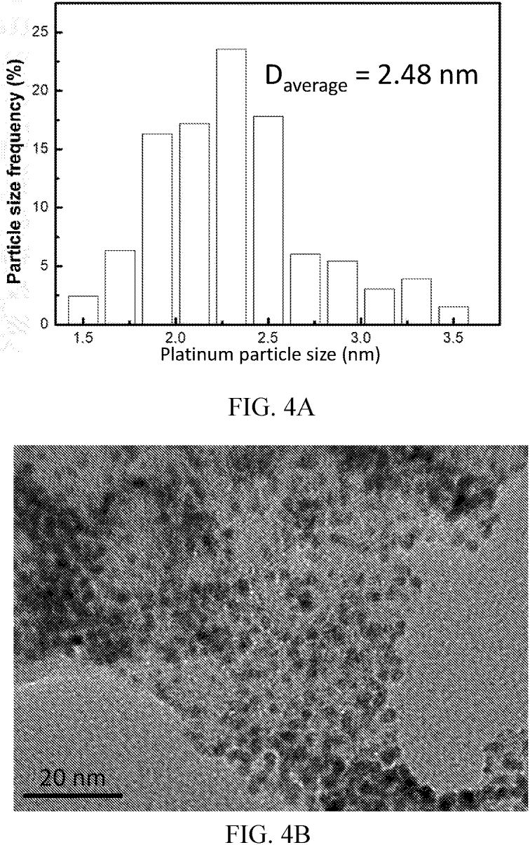

The nanosized platinum nanoparticle colloid as produced in Example 2 was added dropwise after flowing from the spiral glass tube reactor into the carbon ink of Example 4. During the dropwise addition, the carbon ink was vigorously agitated, and the pH of the carbon ink was monitored by a pH detector and controlled below 3.5 by dropwise addition of 0.1 M/L sulfuric acid aqueous solution. The final solid-liquid mixture ink was vigorously agitated at 50° C. for further 5 hours after which the solid was separated from the liquid by high-speed refrigerated centrifuge. The solid was further washed by DI water, freeze dried for 70 hours, and dried in vacuum oven at 80° C. for 12 hours. The final product is labelled as Pt/C-a with platinum content of 40 wt%. The average platinum particle size obtained for this sample is 2.48 nm (see FIG. 4A).

### Example 6 Carbon Supported Platinum Sample Preparation

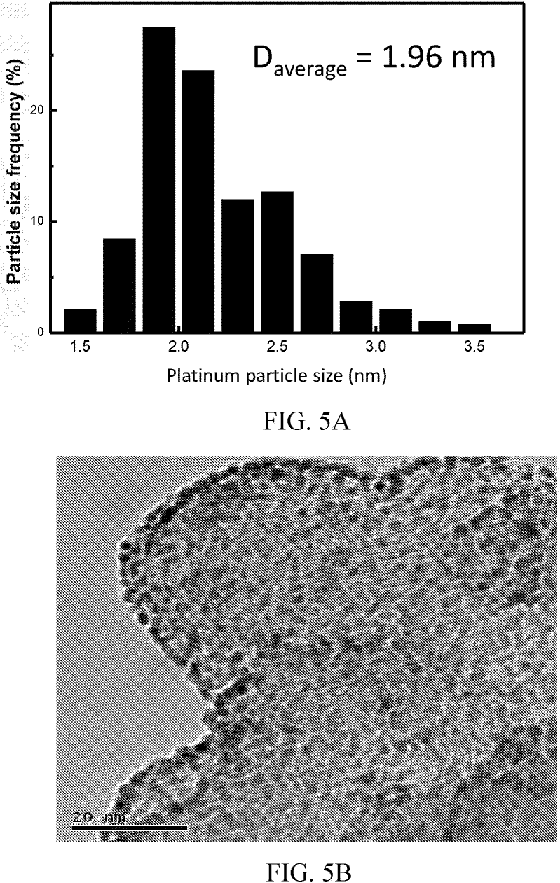

Materials used and procedure were the same as described in Example 5, except the nanosized platinum colloid produced as in Example 3 was used. The final product is labelled as Pt/C-b with platinum content of 40 wt%. The average platinum particle size obtained for this sample is 1.96 nm (see FIG. 5A).

### Example 7 Carbon Supported Platinum Sample Preparation

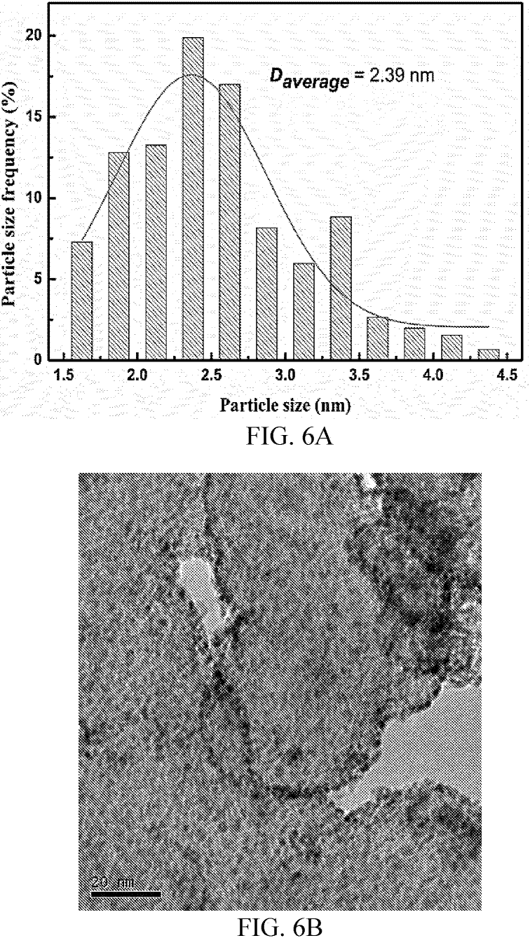

Materials used and procedure were the same as described in Example 6, except the platinum content was 60 wt%. The average platinum particle size obtained for this sample is 2.39 nm (see FIG. 6A).

### Example 8 Graphene Supported Platinum Sample Preparation

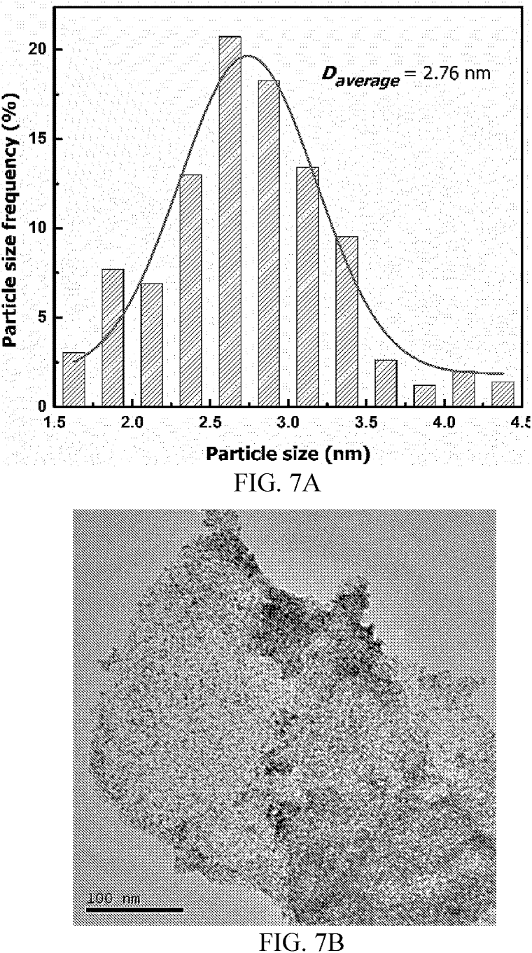

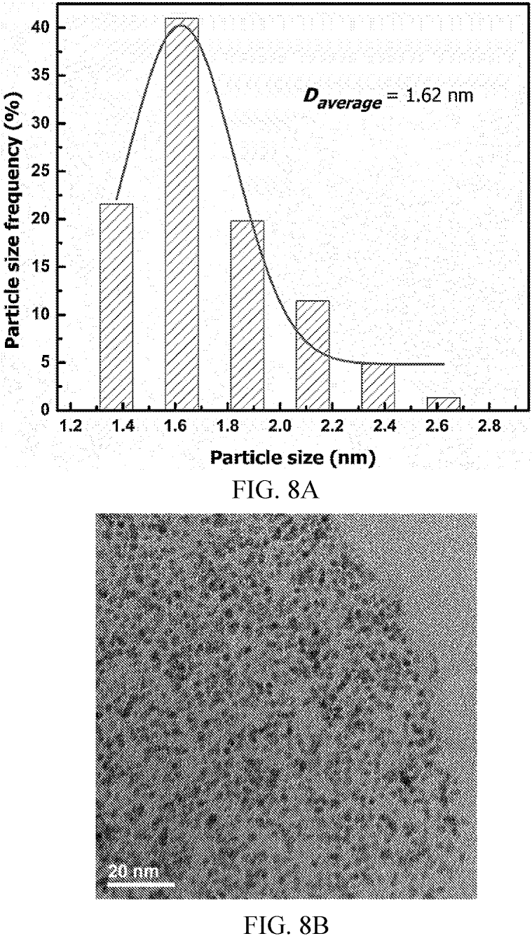

Materials used and procedure were the same as described in Example 7, except graphene oxide was used as the support to produce the support ink. The final product is labelled as Pt/graphene. The average platinum particle size obtained for this sample is 2.76 nm at a platinum loading of 60 wt% (see FIG. 7A), and 1.62 nm at a platinum loading of 30 wt% (see FIG. 8A).

### Example 9 Nanosized Platinum-Cobalt Bi-Metallic Colloid Preparation

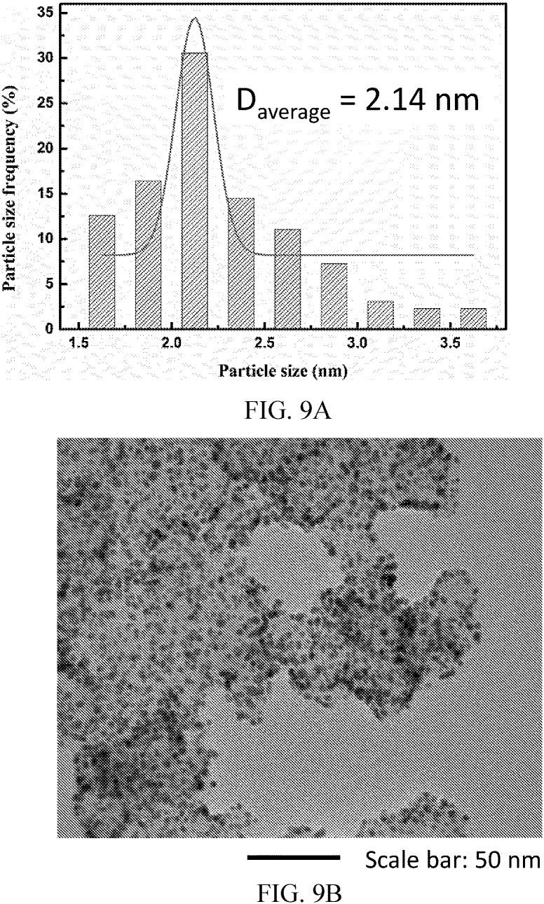

Materials used and the procedure was the same as described in Example 3, except cobalt(II) nitrate hexahydrate (Co(NO₃)₂•6H₂O) was added into the platinum precursor EG solution and stirred at least for 2 hours before potassium citrate tribasic monohydrate (C₆H₅K₃O₇•H₂O) was added into the metallic precursor solution. The molar ratio of platinum to cobalt was 1:3. The molar ratio of hexachloroplatinic acid to citrate was 3. The average platinum-cobalt particle size obtained for this sample is 2.14 nm (see FIG. 9A).

### Example 10 Graphene Supported Platinum-Cobalt Bimetallic Nanoparticle Sample Preparation

Materials used and procedure were the same as described in Example 8, except the metallic colloid of Example 9 was produced and simultaneously used.

### Example 11 Carbon Supported Platinum-Ruthenium Bimetallic Nanoparticle Sample Preparation

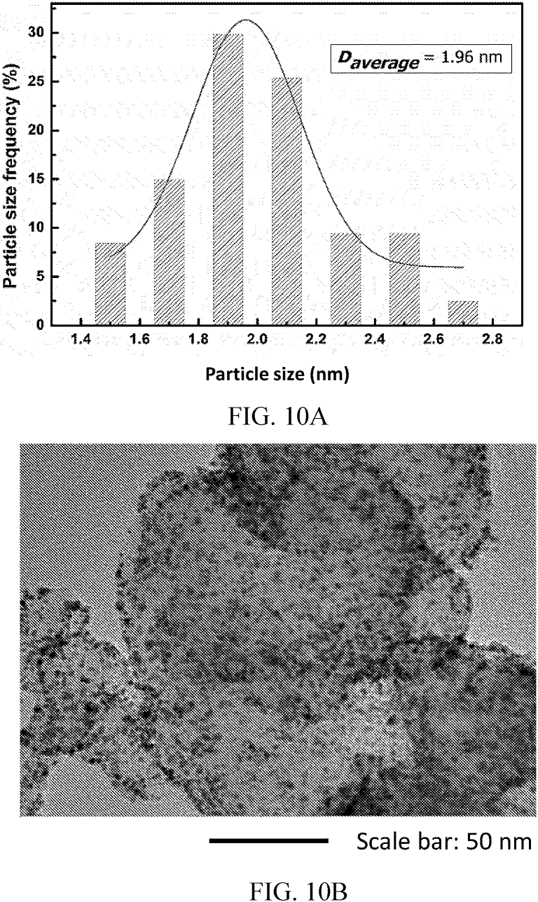

The procedure was the same as described in Example 9 and Example 10, except the cobalt precursor was replaced by ruthenium (III) chloride hydrate (RuCl₃•xH₂O). The molar ratio of platinum to ruthenium was 1. The molar ratio of total metal (PtRu) to citrate is 3. The final product is labelled as PtRu/C in which the total metal content is 50 wt%. The average platinum-ruthenium particle size obtained for this sample is 1.96 nm (see FIG. 10A).

### Example 12 Carbon Supported Platinum-Ruthenium-Iridium Tri-Metallic Nanoparticle Sample Preparation

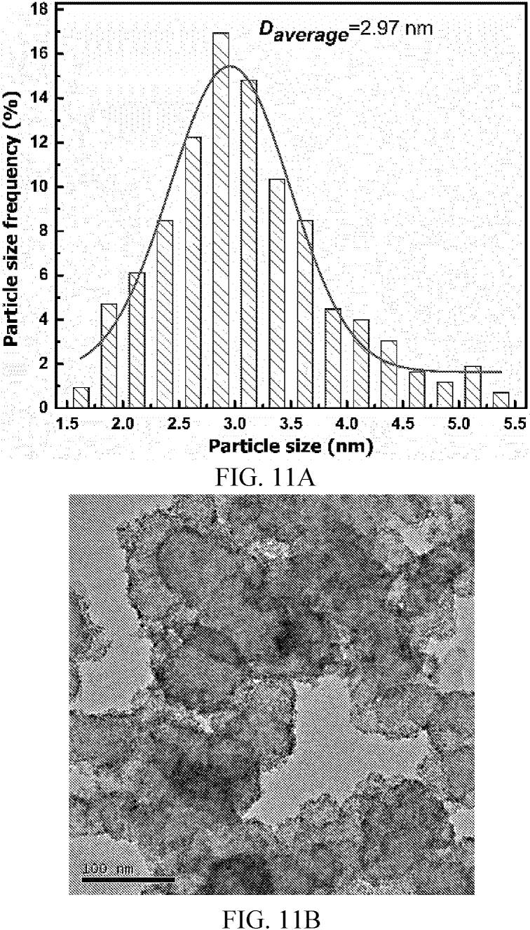

The procedure was similar as described in Example 11 except iridium precursor was added into the metallic precursor solution before the pH adjustment was conducted. The molar ratio of platinum to ruthenium to iridium was 1. The molar ratio of total metal (PtRuIr) to citrate is 3. The final product is labelled as PtRuIr/C in which the total metal content is 75 wt%. The average platinum-ruthenium-iridium tri-metallic particle size obtained for this sample is 2.97 nm (see FIG. 11A).

### Example 13 Carbon Supported Platinum Sample Prepared by Comparative Procedure

The solution of platinum precursor was prepared as described in Example 3 before being reduced. Then the metallic precursor solution was mixed with carbon support ink of Example 4 to obtain the solid-liquid mixture ink. The solid-liquid mixture ink flow was delivered into the microwave heated spiral glass tube reactor in which the reduction reaction was conducted for 10 min at a fixed temperature of 150° C. to obtain another solid-liquid mixture containing the nanosized platinum particles supported carbon particle surface. The solid of the produced mixture was separated from the liquid by high-speed refrigerated centrifuge. The solid (carbon-supported nanosized platinum particles) was further washed by DI water, freeze dried for 70 hours, and dried in vacuum oven at 80° C. for 12 hours. The final product is labelled as Pt/C-c with a platinum content of 40 wt%.

TABLE 1

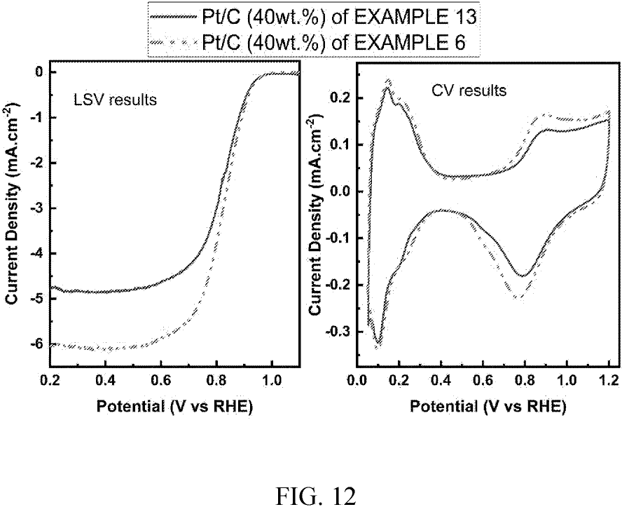

The electrochemical measurement results of Pt/C (40 wt%) samples of FIG. 12

| Pt/C (40 wt%) Sample of | Electrochemical surface area (m².g⁻¹ Pt) | Kinetic Current density (mA.cm⁻²) |
|---|---|---|
| Example 6 (inventive) | 64.2 | 0.95 |
| Example 13 (comparative) | 58.6 | 0.74 |

Example 6 is an example which was prepared in accordance with the presently claimed invention. In contrast, Example 13 is a comparative example, which uses a different reaction sequence from the presently claimed invention. In particular, in Example 13, the support is mixed with the platinum precursor before the solution is heated. Both examples use the same noble metal loading. Heat treatment at 200° C. in hydrogen-nitrogen (5/95) atmosphere for 2 hours was conducted for both samples before electrochemical measurement was done. When comparing the results of Example 6 with the results of Example 13, it can be seen that the noble metal nanostructures on a support as produced by inventive Example 6 have an increased electrochemical surface area and an increased kinetic current density as compared with the platinum nanostructures on a support as produced by comparative Example 13. Specifically, an electrochemical surface area of 64.2 m²/g Pt and a kinetic current density of 0.95 mA/cm² was obtained for Example 6, while only an electrochemical surface area of 58.6 m²/g Pt and a kinetic current density of 0.74 mA/cm² was obtained for Example 13. Since both examples use the same noble metal loading, it can be seen that by using the method as described herein, a higher activity of the noble metal can be achieved, improving the cost-effectiveness of expensive noble metals to a large extent.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for forming noble metal nanostructures on a support, comprising:
mixing one or more noble metal precursor with a first solvent and a base to obtain a noble metal precursor solution;
feeding the noble metal precursor solution to a spiral tube reactor;
heating the spiral tube reactor containing the noble metal precursor solution to reduce the one or more noble metal precursor to obtain noble metal nanostructures;
mixing a support ink with the noble metal nanostructures obtained after heating, wherein the support ink comprises a second solvent, the support and an ink acid.

2. The method according to claim 1, wherein heating comprises irradiation of the spiral tube reactor in a microwave reactor or a millimeter reactor.

3. The method according to claim 1, wherein the noble metal precursor solution further comprises a polybasic carboxylic acid, and/or its salt, wherein the polybasic carboxylic acid, and/or its salt is added to the one or more noble metal precursor with a first solvent before the base is added to increase the solution pH.

4. The method according to claim 3, wherein the polybasic carboxylic acid is selected from a group consisting of citric acid, tartaric acid, malic acid, oxalic acid, or their salts.

5. The method according to claim 1, wherein a pH value of the noble metal precursor solution is higher than 7.

6. The method according to claim 1, wherein the base of the noble metal precursor solution is an inorganic base.

7. The method according to claim 1, wherein a pH value of the support ink, before being mixed with the noble metal nanostructures obtained after heating, is lower than 7.

8. The method according to claim 1, wherein the spiral tube reactor is immersed in a heating medium.

9. The method according to claim 1, wherein the spiral tube reactor has more than one spiral tube, wherein at least two spiral tubes of the more than one spiral tube run concurrent to each other.

10. The method according to claim 1, wherein the one or more noble metal precursor is selected from the group consisting of an oxide, a halide, a nitrite, a sulphate, or a complex of platinum, ruthenium, palladium, gold, silver, rhenium, rhodium, iridium, osmium, and a combination thereof.

11. The method according to claim 1, wherein the noble metal precursor solution further comprises a transition metal precursor.

12. The method according to claim 11, wherein the transition metal precursor is selected from the group consisting of an iron cation, a ruthenium cation, an osmium cation, a cobalt cation, a rhodium cation, nickel cation, an iridium cation, and a combination thereof.

13. The method according to claim 1, wherein the support comprises one or more carbon material selected from the group consisting of carbon black, carbon nanotube, carbon fibre, graphene, graphene oxide, graphite, carbon mesosphere, and a combination thereof.

14. The method according to claim 1, wherein mixing the support ink with the noble metal nanostructures comprises addition of the noble metal nanostructures to the support ink under a controlled pH value of below 5.5.

15. Noble metal nanostructures on a support, which are produced by the method of claim 1.

16. The noble metal nanostructures on a support according to claim 15, wherein the noble metal nanostructures further comprise a transition metal.

17. The noble metal nanostructures on a support according to claim 16, wherein the transition metal is selected from the group consisting of iron, ruthenium, osmium, cobalt, rhodium, iridium, nickel, and a combination thereof.

18. The noble metal nanostructures on a support according to claim 16, wherein a molar ratio between the noble metal to the transition metal is between 10:1 to 1:5.

19. The noble metal nanostructures on a support according to claim 16, wherein the noble metal nanostructures are nanosized alloys and/or nanosized core-shell particles.

20. A method of using the noble metal nanostructures on a support according to claim 15 as an electro-catalyst in an electrode for fuel cell applications.
